(19) United States
(12) Patent Application Publication
(10) Pub. No.: US 2006/0038555 A1
(43) Pub. Date: Feb. 23, 2006

(54) Self-training AC magnetic tracking systems to cover large areas

(76) Inventors: Robert F. Higgins, Richmond, VT (US); Herbert R. Jones JR., Williston, VT (US); Allan G. Rodgers, Jericho, VT (US); James C. Farr, St. Albans, VT (US); Herschell F. Murry, Waterbury, VT (US)

Correspondence Address: John G. Posa;Gifford, Krass, Groh, Sprinkle,, Anderson & Citkowski, P.C., P.O. Box 7021, Troy, MI, 48007-7021, US

(21) Appl. No.: 11/207,098

(22) Filed: Aug. 17, 2005

Related U.S. Application Data
(60) Provisional application No. 60/603,106, filed on Aug. 20, 2004.
(60) Provisional application No. 60/629,788, filed on Nov. 19, 2004.

(51) Int. Cl. G01B 7/30

(52) U.S. Cl. 324/207.17

(57) ABSTRACT

Self-calibrating AC magnetic tracking systems and combination “outside-in” and “inside-out” architectures offer unique motion tracking capabilities. More area is covered with minimal distortion using the tracking system itself to determine overall P&O based on the P&O of an initial, reference marker. The output as anticipated and needed by the user is output without confusion and without costly and time-consuming metrology while covering a large region when distance from the reference may be great. A method according to the invention includes the steps of positioning a plurality of stationary AC magnetic “markers” in a tracking volume and moving a mobile AC magnetic marker proximate to a first one of the stationary markers designated as a reference marker. The position and orientation (P&O) of the mobile marker is determined relative to the reference marker, then moved so as to be proximate to a second one of the stationary markers. The P&O of the second marker is determined relative to the reference marker, allowing the P&O of the mobile marker to be determined relative to the reference marker based upon the P&O of the second marker relative to the reference marker. The stationary markers may be AC magnetic sensors, with the mobile marker being an AC source, or vice-versa.

### REFERENCE TO RELATED APPLICATIONS

This application claims priority to U.S. Provisional Patent Ser. Nos. 60/603,106, filed Aug. 20, 2004 and 60/629,788, filed Nov. 19, 2004, the entire content of both of which are incorporated herein by reference.

### FIELD OF THE INVENTION

This invention relates generally to AC magnetic tracking systems and, in particular, to self-training systems and inside-out and outside-in configurations providing advanced motion tracking capabilities.

### BACKGROUND OF THE INVENTION

In classical AC magnetic tracking systems a single, static source of a three-axis field is detected by multiple sensors which are free to move about a nearby volume (FIG. 1). Systems wishing to cover greater distances can utilize a larger source driven at increasingly higher energy levels. This approach (FIG. 2) has proved difficult, however, since the magnetic near-field drops off as the third order of range from the source. That is, the signal is proportional to k B/r³.

Another factor to be considered is the error signal caused by magnetic signals creating responses that distort data due to eddy currents induced in nearby conductive materials. Although there is controversy over whether distortion is less or greater for pulsed DC or for AC magnetic trackers, in general there is very little difference if the objective is to obtain updates of tracking data very rapidly where stretching of the pulsed DC cycle to allow transients to decay prior to data collection is not allowed.

Although the desired direct magnetic signal and the eddy current distortion signal in theory maintain a constant ratio with energy level, there is a nonlinear phenomenon which alters this constant ratio. When operating at or above the signal level where the nonlinearity occurs, proportionality holds. Consequently, increasing source drive in order to increase operating range creates no benefit over most of the volume because distortion continues as a serious problem. Hence, a large magnetic field source is quite limited in extending useful operating range in distortion-prone environments. Reversal of the source and sensor roles here offers an alternative for covering a larger volume.

If the source drive level is kept low such that the effects of secondary fields from eddy currents tends to fall at or below the noise floor of the sensing circuitry, distortion is rarely a significant problem. In short, the nonlinearity of the noise floor acts as a natural “filter” against the weaker eddy current fields, which must cover much more distance to where the eddy currents are generated and onward to the sensor than does the direct signal. Therefore, if we were to distribute multiple sensors along the periphery of a volume that exceeds the normal source-sensor operating range, then a small, low power source acting as a “sensor” offers the opportunity to track an object over a large volume (FIG. 3) without eddy current distortion being a derogatory factor.

To describe these effects, we will use some recent terminology coined in the literature associated with optical tracking schemes. Such terms usually refer to systems associated with cameras that track reflectors or light sources (e.g. LEDs) supported on an actor. Using such terms, the system in FIG. 2 may be considered an “outside-in” approach, whereas the one of FIG. 3 an “inside-out” approach.

In order to have multiple pseudo-“sensors,” they must be distinguishable from one another, which can be done by operating at different sets of detectable frequencies on each of the three windings. It is important to point out here that the field sources navigating in the subject tracking region can be either wireless or cabled to tracker circuitry since the techniques used can detect and come into synchronization with either as long as the frequency sets are unique.

Operation of several static sensors used to track a source pseudo-“sensor” (which we will refer to as “markers” in the remaining text) raises the issue of maintaining several movement reference points in the volume. That is, there can be another set of coordinates at each sensor. The track of P&O (position and orientation) reported out to the host computer would be quite confusing in this case so that it must be referenced to a common point. This point could be one of the sensors to which all successive measurements can be referenced. Two ways exist, then, for knowing the relative position of all monitoring sensors relative to the reference sensor: use standard spatial measurement sticks, tapes and inclinometers for each sensor, or: have the system do the calibration itself.

AC tracker literature makes no distinction between whether the source or the sensor are static or moving; rather, the position and orientation (P&O) are simply reported as relative to one another. In some later disclosures the concept of making the source(s) move and leaving the sensor(s) static was given innovative stature nevertheless. However, the systems cited used sources and sensors tethered through cabling in order to simplify the engineering problem of signal detection, synchronization and tracking between source and sensor.

The advent of microcircuits improved battery longevity and more sensitive receiving circuitry as well as providing significantly more cost effective processing. Now they help make possible wireless field sources which can generate detectable signals of sufficient strength for tracking and do so for at least an hour before battery recharging. The consequence of this situation is that small 3-axis field sources now offer a way to achieve wireless P&O tracking without the need of radio links if on-the-fly signal detection and synchronization can be provided for small wireless field sources (FIG. 4).

Several issued patents deal with tracking the movement of passive sensors relative to a stationary source of AC magnetic fields. U.S. Pat. No. 4,054,881 to Raab is one example of these teachings. Tracking of remote sources with sensors is one subject of U.S. Pat. No. 6,188,355 to Gilboa. In this reference, Gilboa makes claims for the source being wireless under several constraints for achieving synchronization between the source signals and the sensors. In one embodiment there is a requirement to switch the wireless source and the tracking sensors back and forth between transmit and receive in order to obtain synchronization between them. These and other constraints have been overcome by our approach described in our co-pending U.S. Provisional Patent Application Ser. No. 60/577,860, the entire content of which is incorporated herein by reference. Gilboa, however, does not address the issue of defining the region in which his wireless sensor navigates, apparently counting on a single sensor reporting the P&O relative to the source.

We have found no teachings directed to self-calibration or self-location of the monitoring sensors used to track a source over a large volume. Nor do we know of a system whereby time multiplexing between two field sources is used to gain coverage over a larger area, but such an approach halves the tracking update rate. Nowhere have we found teachings of the self-calibration or self-location of distributed low power sources to cover a large region for mobile sensors, which is the logical inverse of tracking a mobile source with distributed sensors. This use of a tracking system to accomplish the calibration seems absolutely essential as an easy way to apply such a system so that all data reported out of the system using multiple sources is referenced to a single source, the reference source in the environment. Thus a user needs only to know the location of that one source while the tracking system(s) assumes the responsibility of reporting out all tracking data relative to that one reference location.

U.S. Pat. No. 6,681,629 to Foxlin teaches the tracking of limbs, etc. on a person or object relative to a local reference point and then relaying that to a fixed reference that is tracking the person or object in a moving environment. This technique is applicable most directly for inertial systems being used in a mobile environment. In particular, Foxlin claims use of a non-inertial tracker in an inertial referenced moving platform, which we believe to be a moot point since trackers such as AC magnetics always do measure the correct tracking data regardless if the platform is moving or not. In addition, it is to be noted that inertial measurement within a moving platform of, say, a pilot's helmet P&O requires that the aircraft movement be extracted by airframe sensors in order to obtain an airframe-referenced data result.

### SUMMARY OF THE INVENTION

This invention broadly resides in self-calibrating the AC magnetic tracking system, and combination “outside-in” and “inside-out” architectures offering unique motion tracking capabilities. A goal of the invention is to cover more area with minimal distortion, and use the tracking system itself to determine overall P&O based on the P&O of an initial, reference marker (or magnetic field sources or sensors). In this way the tracking system can report the output as anticipated and needed by the user without confusion and without costly and time-consuming metrology while covering a large region when distance from the reference may be great.

Apparatus and methods are described. A method according to the invention includes the steps of positioning a plurality of stationary AC magnetic “markers” in a tracking volume and moving a mobile AC magnetic marker counterpart (i.e., sensor for sources; source for sensors) proximate to a first one of the stationary markers designated as a reference marker. The position and orientation (P&O) of the mobile marker is determined relative to the reference marker, then moved so as to be proximate to a second one of the stationary markers. The P&O of the second marker is determined relative to the reference marker, allowing the P&O of the mobile marker to be determined relative to the reference marker based upon the P&O of the second marker relative to the reference marker.

The stationary markers may be AC magnetic sensors, with the mobile marker being an AC source, or vice-versa. Any number of stationary markers may be present in the tracking volume. Although position and orientation (P&O) may be computed in a sequence along any continuous path of a moving marker based on the P&O of a beginning, reference position, to minimize error accumulation the reference marker is preferably surrounded by stationary markers as opposed to being at the end of a linear array. In all embodiments, the sources may be wireless, cabled from another tracker, or otherwise not connected to the tracking system.

To facilitate rapid re-start, the coordinates of the stationary markers for future use the stationary markers may also be provided on a fixture, such that after the completion of initial calibration steps only the P&O of the mobile marker relative to the reference marker need be determined for a subsequent use of the system. If the markers are sources, it is presumed that they operate on different frequency sets. The mobile marker in this case may include a plurality of AC magnetic sensors in communication with one another. The signal strength associated with the sources may also be taken into account when determining the P&O of the mobile marker.

According to the “sensor learn” embodiment of the invention, at least one 3-axis field source, operating at a set of frequencies for the three orthogonal axes, is detected at one reference three-axis sensor. The result is then used to locate subsequent monitoring sensors in the three-dimensional measurement space. The sources can be operated under pre-determined rules, which allow an environment to be lined with monitoring sensors that can be used to report back to the outside world measurements relative to the reference sensor. In this way, the system itself can be used to align its measurement space for meaningful results to the measurement sensor although the range from reference sensor to a later position of the source can be far out of range from normal coupling of signals between them but still be properly referenced geometrically.

In the “source learn” configuration, at least one 3-axis reference field source, operating at a set of frequencies for the three orthogonal axes is placed in a fixed location, detected with a three-axis sensor, and its P&O is computed. Then the P&O determined from subsequent sources distributed in the environment can be translated and rotated to the location coordinates of this reference source. Subsequent fixed sources operating at a different frequency set can be located in the same way and have their P&O measurements translated and rotated to the location of the reference source. These sources operated under these simple rules allow an environment to be traversed with sensors whose P&O measurements always can be reported back to the outside world relative to the reference source. In this way, the system itself can be used to align its measurement space for meaningful tracking results over extended ranges far outside normal coupling of signals between individual source and sensor sets but still be properly referenced geometrically while avoiding most field distortion because of the small fields and short source-sensor separations.

Thus, depending upon the configuration, the tracking system learns the source placement configuration and then reports subsequent results referenced to a particular small field source location. In an alternative embodiment, signal source markers are tracked by fixing sensors in place, and then the tracking system learns their locations based upon the location of a single sensor. In a robust implementation supporting both “inside-out” and “outside-in” operation, the sensor/source learn concepts are combined to yield still more novel options for 3D tracking system configurations. Distributed sources operating at different, distinguishable frequency sets and sensors monitoring mobile “marker” sources also operating at different frequency sets provide unique motion tracking architectures. Further, these system configurations also exhibit the characteristic of reduced field distortion through short source-sensor separations.

### BRIEF DESCRIPTION OF THE DRAWINGS

FIG. 1 is a diagram showing a classical AC magnetic tracking system;

FIG. 2 is a diagram which shows how large field sources can produce more distortion;

FIG. 3 is a diagram which shows how “pseudo sensors” or markers can be used to cover a large region with less distortion;

FIG. 4 is a diagram that shows wireless field source “markers” being tracked;

FIG. 5 is a drawing which shows a source marker brought near a first sensor in a tracking volume;

FIG. 6 is a drawing which shows a source marker brought near a second sensor in a tracking volume;

FIG. 7 is a drawing which shows a source marker brought near a third sensor in a tracking volume;

FIG. 8 is a drawing which shows a source marker brought near a fourth sensor in a tracking volume;

FIG. 9 is a drawing which shows a source marker brought near a fifth sensor in a tracking volume;

FIG. 10 shows a plurality of wireless or wired sources positioned relative to a plurality of sensors according to the invention;

FIG. 11 is a diagram which shows a tracker using a first source as a reference;

FIG. 12 is a diagram showing a tracker relative to a second source;

FIG. 13 is a diagram showing a tracker relative to a third source;

FIG. 14 shows a tracker with three sensors moving through an environment;

FIG. 15 shows two two-sensor trackers in the environment;

FIG. 16 shows trackers with a varying number of sensors;

FIG. 17 also shows trackers with a different, varying number of sensors attached;

FIG. 18 shows several more sources added to an environment to enlarge volume coverage;

FIG. 19 shows how the position and orientation from a first source is used as a reference;

FIG. 20 shows how as the tracker and sensor move along, they acquire a second source;

FIG. 21 shows the acquisition of a third source, with a learning process being repeated;

FIG. 22 illustrates the acquisition of a fourth source;

FIG. 23 depicts an inside-out tracker based upon LATUS (Large Area Tracking Untethered System) sensors;

FIG. 24 shows a single field source placed in an environment relative to a sensor interface to tracker electronics;

FIG. 25 shows the sensor and tracker electronics relative to a second source;

FIG. 26 illustrates the sensor and tracker electronics moving toward additional sources;

FIG. 27 illustrates the use of multiple sensors interfaced to tracker electronics;

FIG. 28 illustrates the use of multiple sensors interfaced to a plurality of tracker electronics;

FIG. 29 illustrates the use of a different configuration of sensors interfaced to a plurality of tracker electronics;

FIG. 30 illustrates fixed sources for sensors to track “outside-in,” wherein position and orientation is produced in mobile trackers connected to the sensors;

FIG. 31 shows fixed sensors tracking “markers” for an “inside-out” arrangement, wherein marker position and orientation data comes out of the system connected to the sensors; and

FIG. 32 illustrates a combination “outside-in” and “inside-out” magnetic tracking system, reporting several choices for producing position and orientation data.

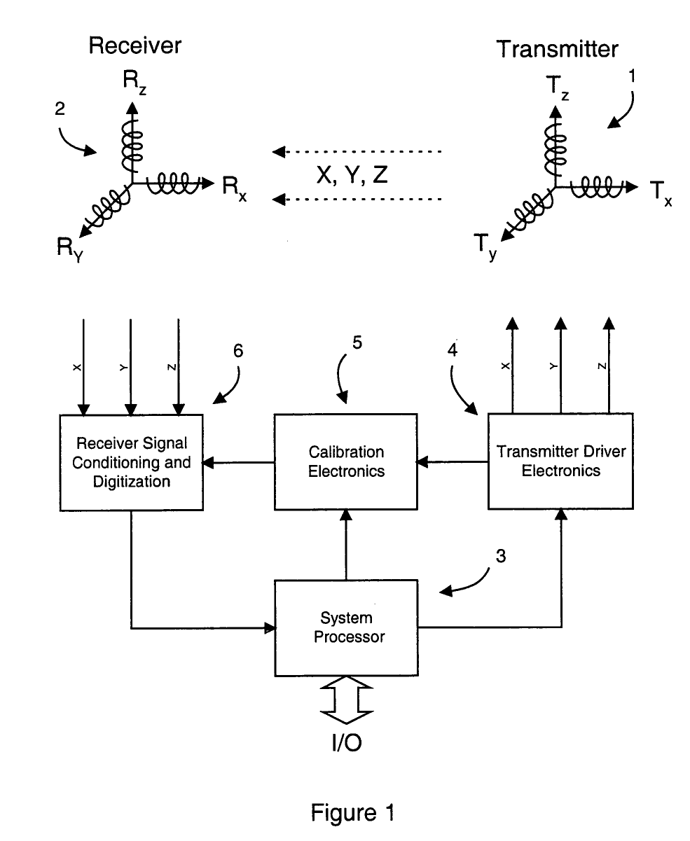

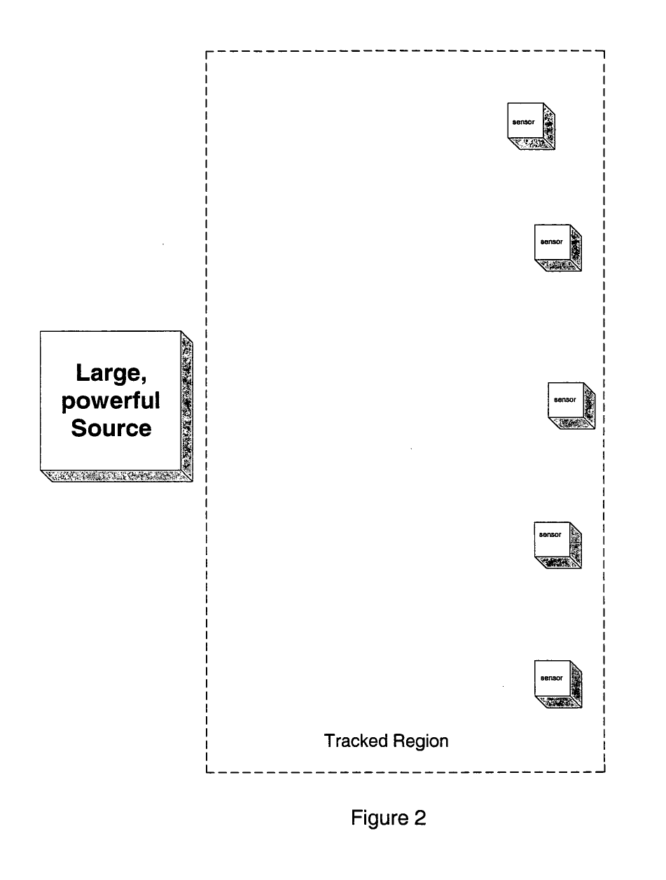

### DETAILED DESCRIPTION OF THE INVENTION

An important aspect of this invention is to use the tracking system itself to determine P&O in a sequence along any continuous path of a moving “marker” based on the P&O of a beginning, reference position. In this way, the tracking system can report the output as anticipated and needed by the user without confusion and without costly and time-consuming metrology. The approach is applicable to sensor and source learning in conjunction with both outside-in and inside-out structures. By virtue of the invention, the system itself assumes the responsibility of reporting out all tracking data relative to a single reference point.

In a first example described herein below, we teach the use of a tracking system to learn the source placement configuration and then report subsequent results to the outside world referenced to a particular small field source location. According to a second disclosed example, we teach how signal source markers can be tracked by fixing sensors in place, and then having the tracking system learn their locations for reporting to the outside world data referenced to the location of a single sensor. A third example teaches how both techniques can be combined to achieve unique motion tracking capabilities.

The various embodiment may further take advantage of the ability to detect and track sources operating independently without signal coherence, a concept which has been introduced in a co-pending U.S. Provisional Patent Application Ser. No. 60/577,860, the entire content of which is incorporated herein by reference.

Inside-Out “Sensor Learn” Embodiments

If one desires a remote “sensor” to track, it really does not matter whether the source or sensor is tracked because the position and orientation (P&O) calculation is the relative P&O between source and sensor. If a mobile source is to be tracked in the environment, its coordinates must be reported relative to those of a reference sensor. As the source “marker” moves closer to another real sensor, if coordinates are to be reported in a consistent manner based on the reference sensor, the P&O of the next monitoring sensor must be known relative to the reference sensor. Stated differently, inside the tracking system the coordinates being measured are between the source and the closest monitoring sensor, but this means nothing to the outside world which is awaiting the P&O data report. If the relative monitoring sensor coordinates have been measured by meticulous instrumentation and stored in the system, the needed data can be computed.

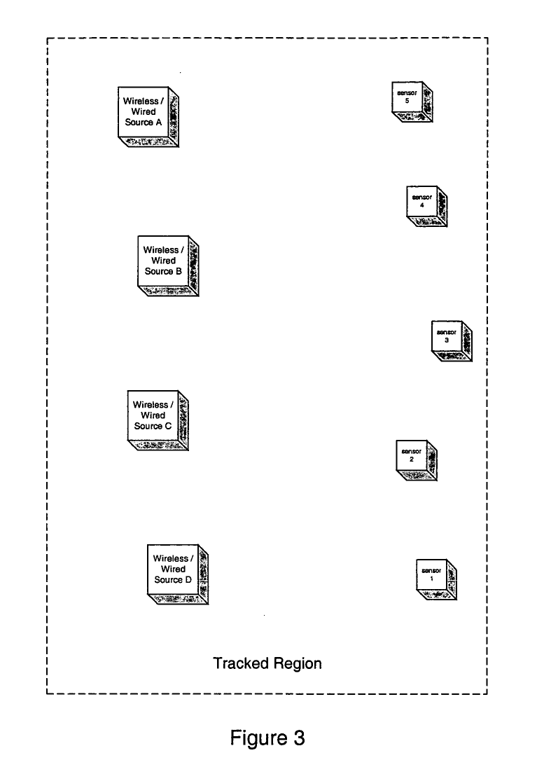

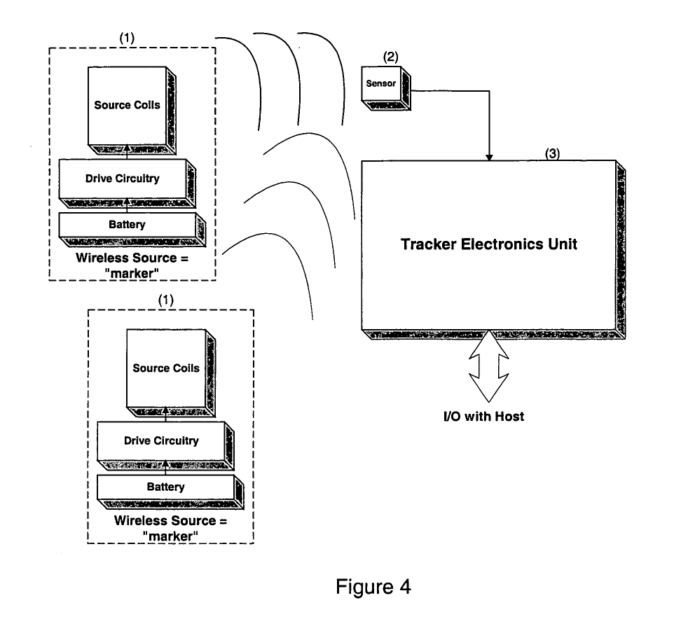

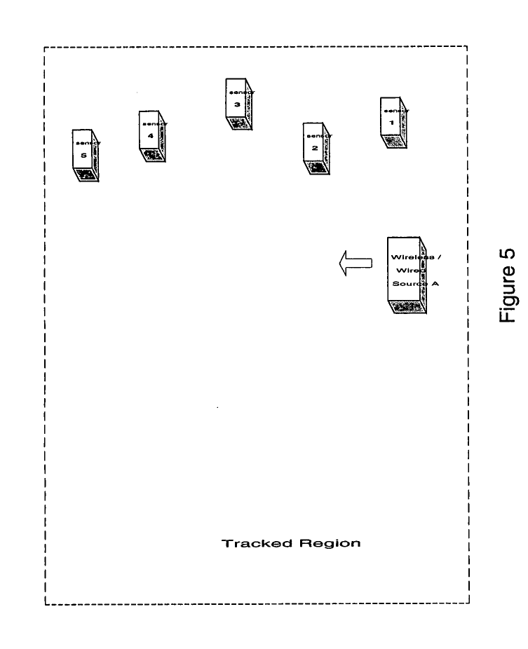

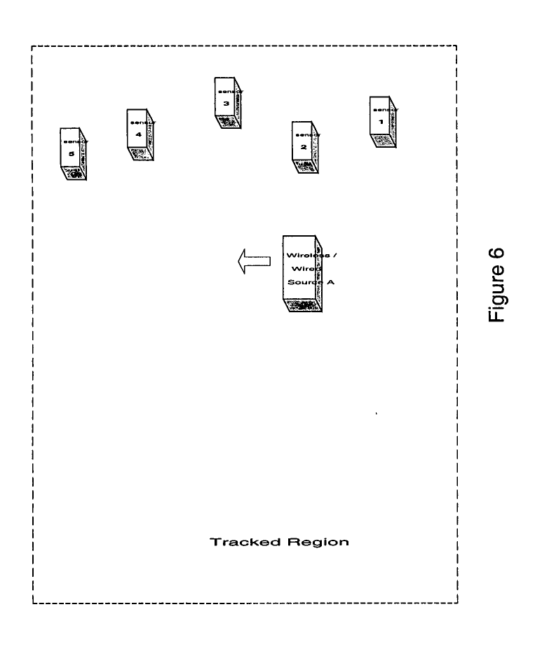

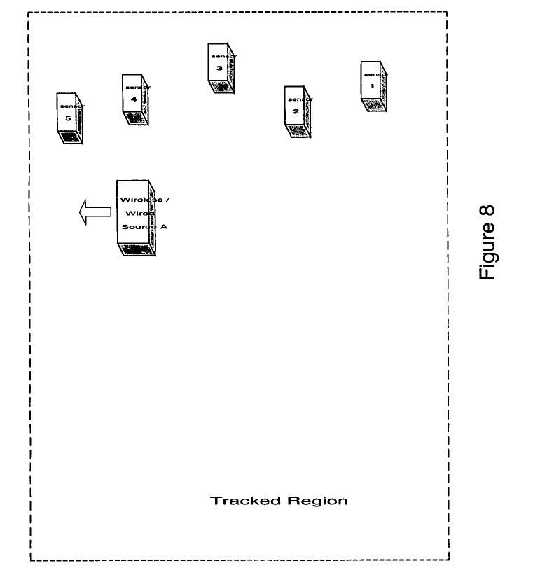

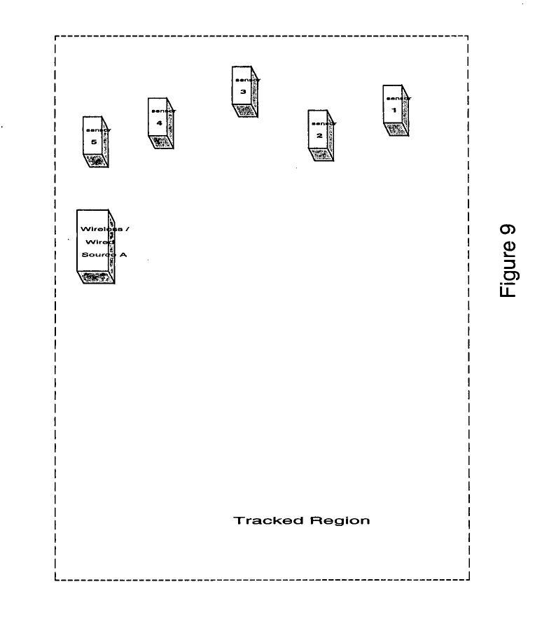

In order to explain this process of self-calibration of the monitoring sensors a series of figures similar to FIG. 3 are presented in FIGS. 5 to 9. In FIG. 5, the source “marker,” denoted as “A,” is brought near sensor 1, used as the reference, before moving onward to sensor 2 (FIG. 6). There are some conditions on these approaches that need discussion later, but for now we follow the source through the sequence of monitoring sensors to be self-located. The amount of signal being received at sensors 1 and 2 is computed (actually the amount received at all sensors is computed on an ongoing basis, but in the present explanation we can keep it simple) so that it can be determined when sensor 2 has a strong enough signal such that its coordinate readout should be considered as a correct answer.

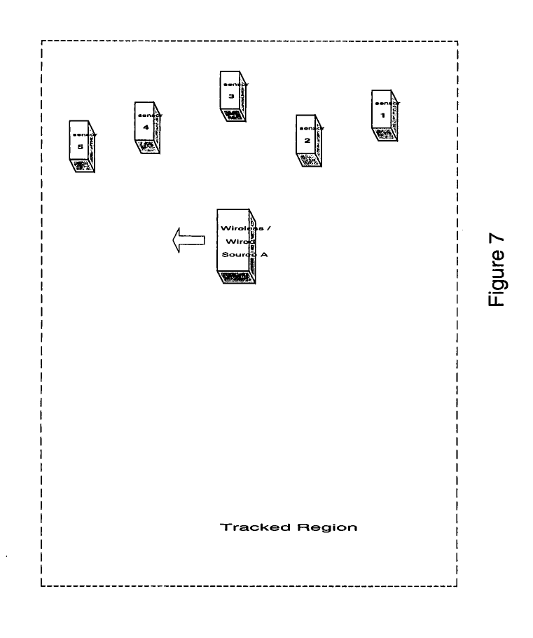

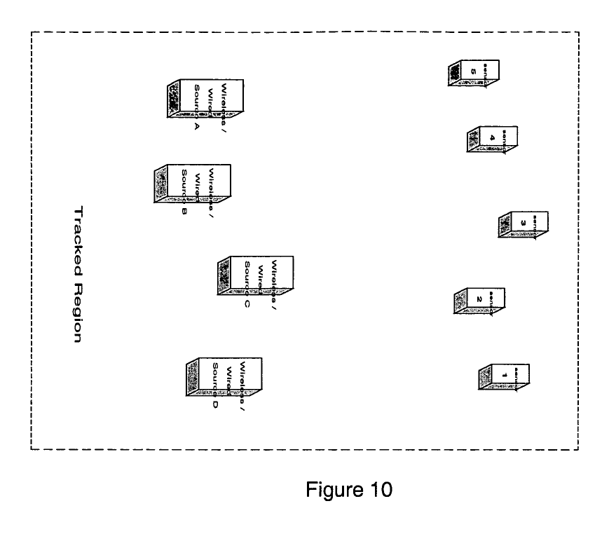

Since sensor 1 has the P&O of the source from its own location, it can use the readout from sensor 2 of its view of source P&O to compute the relative location of sensor 2 from that of itself. These coordinates are then available to translate and rotate marker data to the reference sensor coordinates. Another issue solved in the method is one that arises when tracking via the use of magnetic dipoles where dual answers for position occur because of field symmetry by hemisphere. The self-locating algorithm fits the dual positions in the comparison between sensor position (the initial sensor being known or “trusted”) to always choose the correct tracking hemisphere. As the marker A is moved onward to sensor 3 (FIG. 7), the process is repeated so that its coordinates can be related to the reference sensor, including correct hemisphere. And so it goes through the five sensors depicted in this example. Then the other markers B, C, . . . can be brought into the environment without further concern for locating the reference and monitoring sensors, as shown in FIG. 10. Reference and monitoring sensors need no further locating so that all markers can proceed to move about freely as output data are referenced to a single point.

A few comments are in order for optimizing system set-up. Locating the monitoring sensors by this easy method is of course dependent on system accuracy to obtain true sensor locations. If an environment is established in a linear arrangement as shown in the example figures, the system error could accumulate to make the location of sensor 5 the least accurate (of course it is a statistical matter, but the worst case would make this location the worst). Hence, depending on the geometry of the region to be used, including the entry of new markers for the first time, may favor putting the reference somewhere in the center so that errors cannot accumulate to as great an extent.

Another important point in taking the system through this “learn” mode is to inform the tracker system that the sensor outputs are to be self-located and transferred to the reference sensor for subsequent tracking rather than to report out as marker location. A switch actuation or host computer command can do this, starting at the reference sensor. Such a switch/command indicates to the system that a new configuration is to be determined, or “learned,” rather than to continue reporting output data to a previous (or non-existing configuration in the case of a new start-up) configuration. The switch/command actuation process was omitted for simplicity in the earlier explanation of the example of FIGS. 5 to 9, but it must occur so the system software for each sensor in a new system configuration is informed of the configuration change.

Power ON/OFF sequences and future changes to the system configuration are also important. The locations of the monitoring sensors to be translated to the reference sensor for data readout can be stored in non-volatile system memory for recall at the next power ON. Further, several environments could be created whereby the array of known tracking sensor positions are available and saved in order to avoid re-learning the locations as different system configurations. The appropriate system configuration can be invoked prior to power OFF so that it is the one returned at system power ON. One way of achieving different repeatable configurations is to have accurate placement hardware for re-locating the sensors in a grouping so that prior configurations can again be assembled accurately. However, once a monitoring sensor(s) is(are) moved to new, unknown location(s) the system configuration must go through another “learn” mode operation in order to determine the monitoring sensor location(s). If an array of tracking sensors is on a fixture that already has been learned by the system, only the reference sensor location will need to be learned after a stored configuration is re-invoked. By being able to accomplish configuration alignment using the tracking system itself, the learn mode is a rapid process placing very little burden on the user, unlike having to use metrology tools to mechanically locate sensors.

It is worth repeating that the “markers” can be either wireless or wired and directly driven cabled sources containing the correct system frequency signal sets. In other words, the learning process places no constraint on the marker signals except that they create signals from a frequency population consistent with the system so that there can be both wireless and wired sources being tracked as markers. In a given environment the frequency sets cannot be repeated.

Outside-In “Source Learn” Configurations

If one desires to track motion in a large area with a magnetic tracker the prevalent approach has been to create a large field source and drive it hard enough to couple signals to the remote sensors moving in the volume. The strong field, however, creates enough eddy currents in nearby conductors to cause distortions that can make the sensor data worthless or necessitate a complex process to be invoked to calibrate out the distortion. If the fields can be kept much smaller and be distributed over the volume so source-sensor separation can be kept short, then distortion is very much smaller problem. Any distortion that could occur then disappears into the sensor noise floor. By this approach a larger motion tracking workspace still can be created.

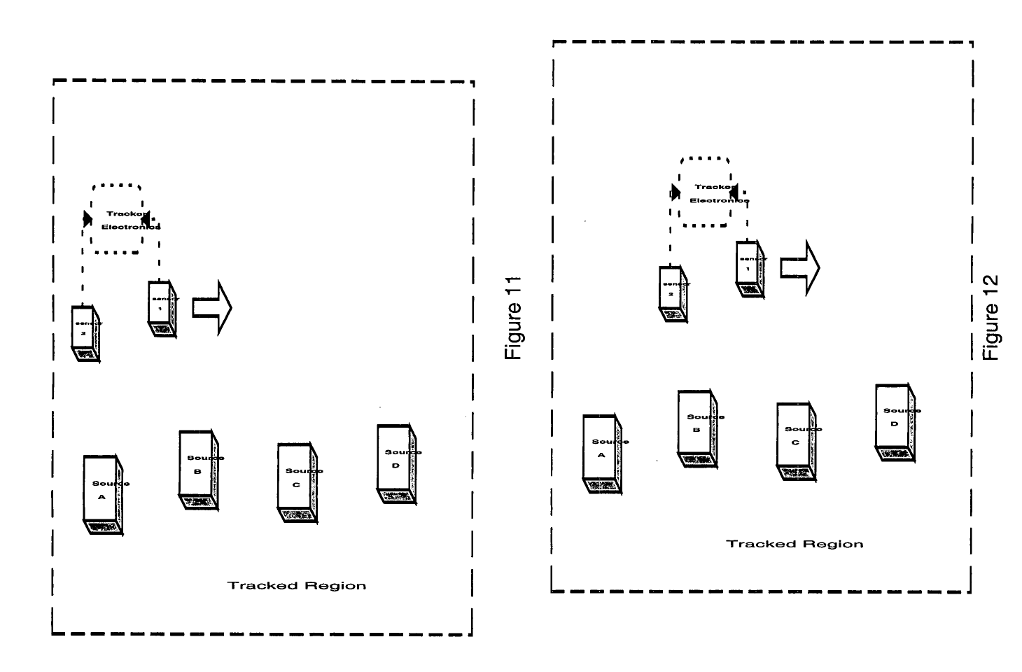

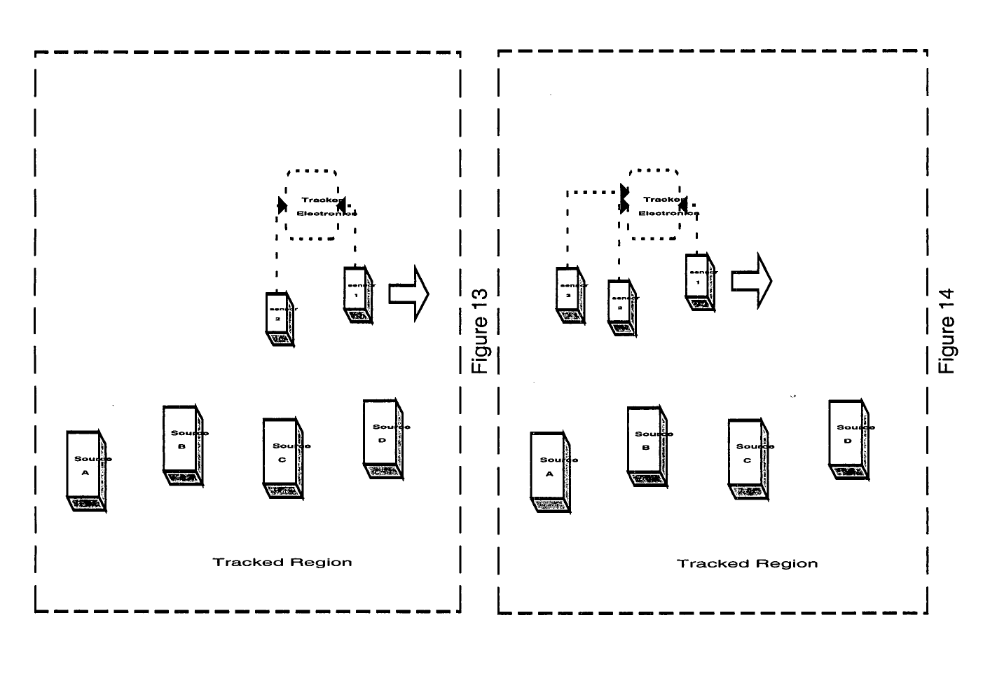

Unfortunately, even if the tracker electronics can detect signals from multiple sources and use them to track a sensor, each P&O solution will be referenced to each source. This would prove to be very cumbersome. Referencing all measurements back to a single source location is highly desirable, and the motion tracker can have the capability of doing this. Hence, the first source detected is used as a reference. As movement continues to the next source, it will be detected and a P&O computed for it. This second P&O can then be translated and rotated to the coordinates of the first source, within whose coupling the sensor still would be located by computing the delta P&O of the two sources. Then as movement totally leaves the reference source the stronger signal off the second source will be used to compute a P&O that is translated and rotated back through the reference coordinates. As the sensor moves along to encounter an additional source the process is repeated with its P&O also translated and rotated to the reference source. Mechanically, this is depicted in FIGS. 11-14, where the tracker is using source A as the reference.

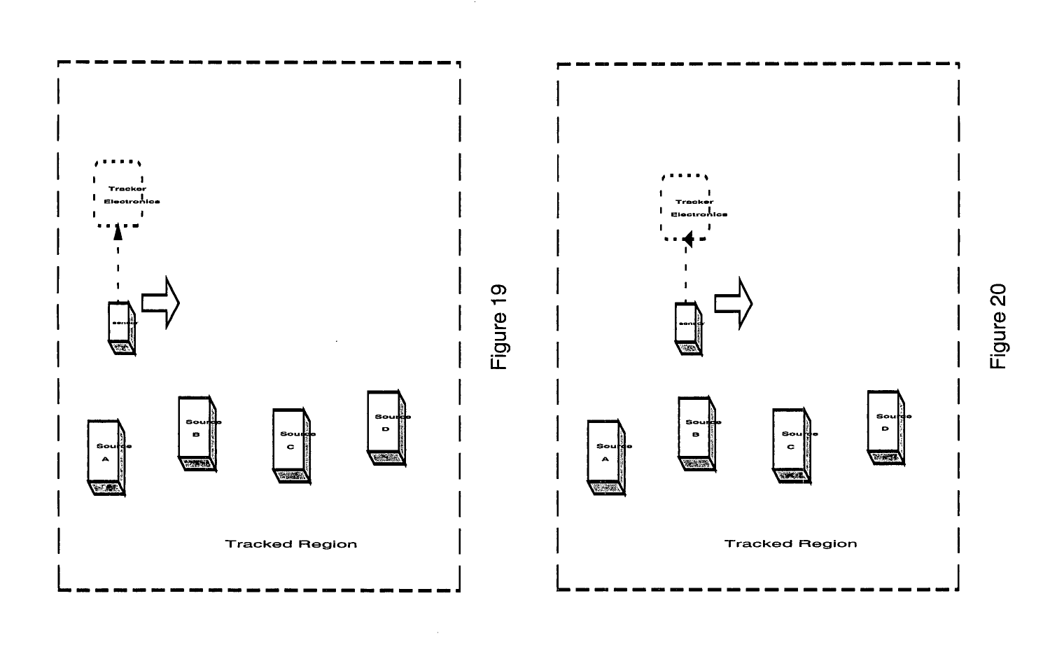

The simpler set of FIGS. 19-22 should provide additional clarification. In FIG. 19 the P&O from source A, what is being used as the reference, will need no alteration (the user, of course, could always translate and rotate results referenced to this source to any other point in the environment). As the tracker and sensor move along in FIG. 20 to acquire source B, two results exist: 1) the properly referenced P&O from A and 2) what we might call “raw” P&O computed from B. The sensor “knows” its P&O relative to A and the P&O relative to B. Therefore the P&O from B is known relative to A. This can be used to compute sensor P&O relative to reference source A. One final detail exists, however. The first time, for instance, a raw P&O can be computed from B perhaps the signal strength from A is much greater than the strength from B. Hence, criteria such as a signal threshold level must be met before being declared the “true” P&O relative to A. As B gets stronger after its location relative to A has been learned, its result is refined and weighted stronger on B than A. In other words, future P&O is weighted based on signal strength from the various sources.

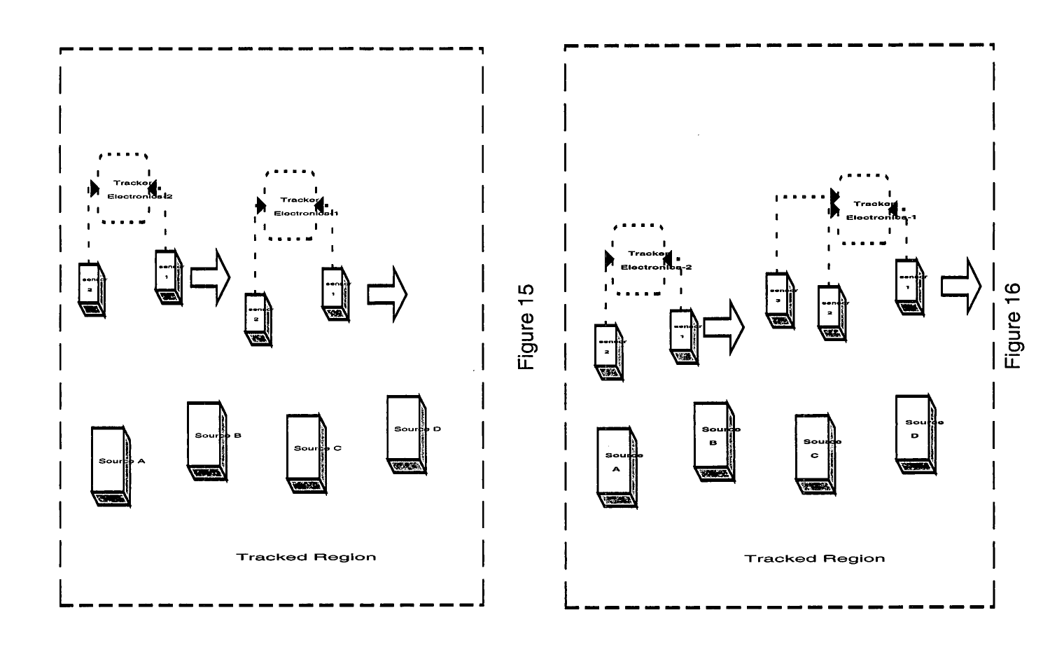

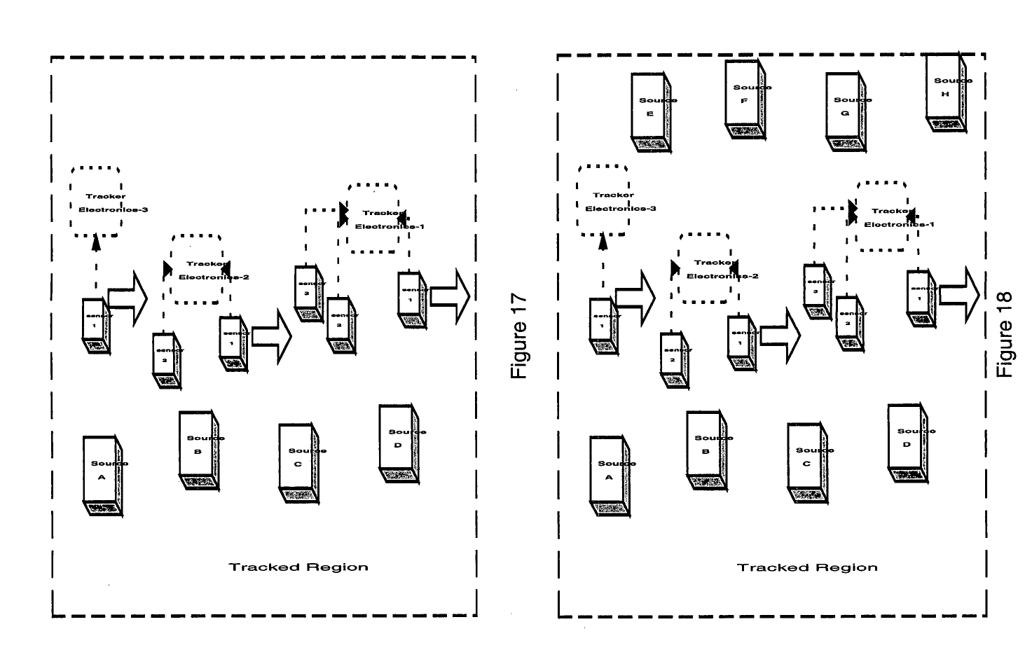

Note also that the tracker may have more than one sensor, for example, the tracker and host processor may be in a body pack of a user who is walking through the scene with a sensor on his head and another on his hand. Alternatively, the tracker and its host may be placed statically by the environment and two cabled sensors may be attached to the user. FIG. 14 shows a tracker with three sensors moving through the environment. FIG. 15 shows two two-sensor trackers in the environment, and FIGS. 16 and 17 show trackers with varying numbers of sensors attached. Each can operate independently and report back coordinates related to reference source A. FIG. 18 shows several more sources added to the environment to enlarge it to cover more volume. Nevertheless, all P&O data coordinate reports are referenced to the location of the reference source A.

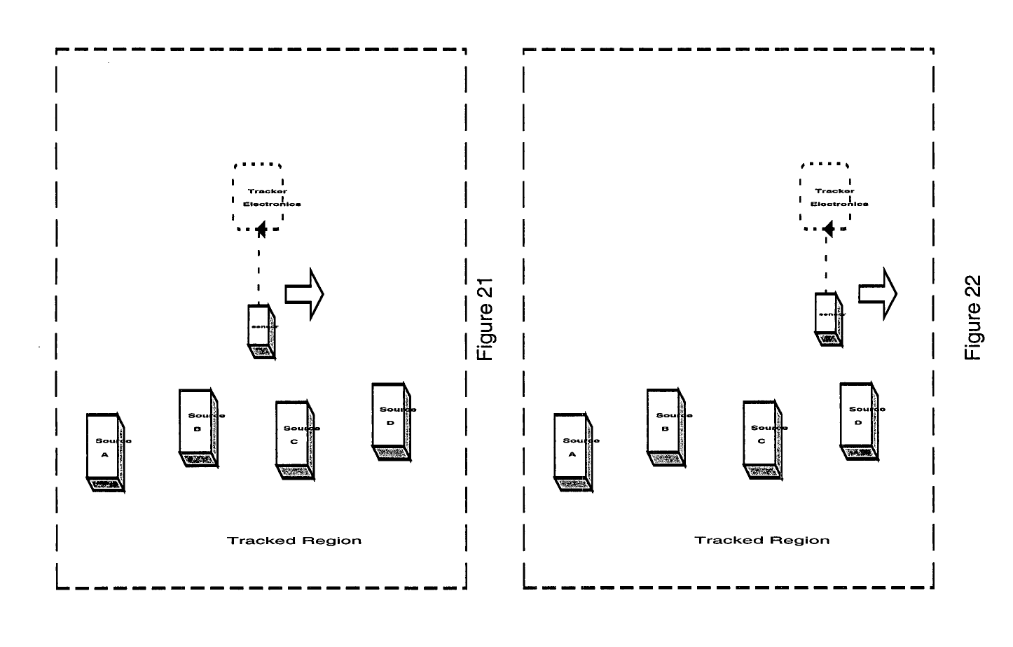

In FIG. 21 as the sensor acquires source C this learning process is repeated as it is again with D in FIG. 22. Afterwards the “raw” P&O gets related to A and then weighted by all source signal strengths intercepted before being the next “true” P&O. And so it goes onward through all sources. As separation increases from A the result in applying weighting may mean that A has little or no influence because of low (or no) signal level, but the “true” P&O is weighted by the signal strengths of the other sources and reported as though it is related to A, the system reference. Additional sources can be brought in to establish a larger environment such as sources E through H in FIG. 18, and the above process/algorithm is repeated. For instance, a sensor in the center of the tracked region may have a small weighting applied for all sources before reporting out its “true” P&O, which would still be referenced to A.

A constraint on tracking systems using this technique is the use of the same reference source if data are to be analyzed by the outside world. However, if each tracker consumes the results internally, each could use a different reference as long as no other data from the outside world is referenced to a different source. Such an application may be difficult to implement, but it is nevertheless possible.

A few comments are in order regarding optimization of system set-up. Of course, each source must operate on a different frequency set. The sources should be located so that at least two are in range of a sensor as the source locations are being established inside the environment after passing the reference source. If an environment is established in a linear arrangement rather than a matrix of sources covering a broader region, the system error could accumulate to make the location of sources farther along the line less accurate. Hence, depending on the geometry of the region to be used, including entry of new tracking sensors for the first time, choosing the reference somewhere in the center so that errors cannot accumulate to as great an extent may be advisable.

It should be mentioned here that the ability to detect and track sources operating independently without signal coherence has been introduced in U.S. Provisional Patent Application Ser. No. 60/577,860, the entire content of which is incorporated herein by reference. Also, in starting the system, it should be told which source is to be the reference if this is important to the overall system operation in the environment to save the geometric relationship learned about the source locations. A switch actuation or host computer command can do this, starting at the reference source. Such a switch/command indicates to the system that a new configuration is to be remembered rather than to continue reporting output data to a previous configuration (or non-existing configuration in the case of a new start-up). The switch/command actuation process was omitted for simplicity in the earlier explanation, but it must occur if the system software is to relate measurements to that location. Otherwise, the starting point is arbitrary.

Should one wish to halt tracker operation and then start up again without initiating operation by the reference source at power ON/OFF sequences, the source translation coordinate configuration must be saved. The locations to the reference of known sources can be stored in non-volatile system memory for recall at the next power ON. In the instance where a user may have multiple environments established with different arrays of sources (e.g. multiple animation mocap studios) the tracker(s) could store the various configurations and then have them invoked when transiting from one environment to another and have instant reporting of data to the proper reference in each case. It is worth mentioning again that an external user also could establish a reference point somewhere other than the reference source and use his processor to translate and rotate all results to a desired reference.

Although the above discussion and figures have referenced independent sources, it must be pointed out that wireless and sources cabled to a tracker containing the correct system frequency signal sets could be used as well. In other words, the process places no constraint on the sources except that they create signals from a frequency population consistent with the system, such frequency sets not being repeated in a given environment. Using the system itself to align the coordinates of these source configurations is a great time and labor savings over using mechanical schemes.

Combination “Outside-In” & “Inside-Out” Structures

The technique of tracking passive sensors due to an external source of signals often is referred to as an “outside-in” tracker system while the use of active markers moving through the environment to be tracked by passive sensors often is referred to as an “inside-out” tracker system. What follows is a combined architecture using “outside-in and inside-out.”

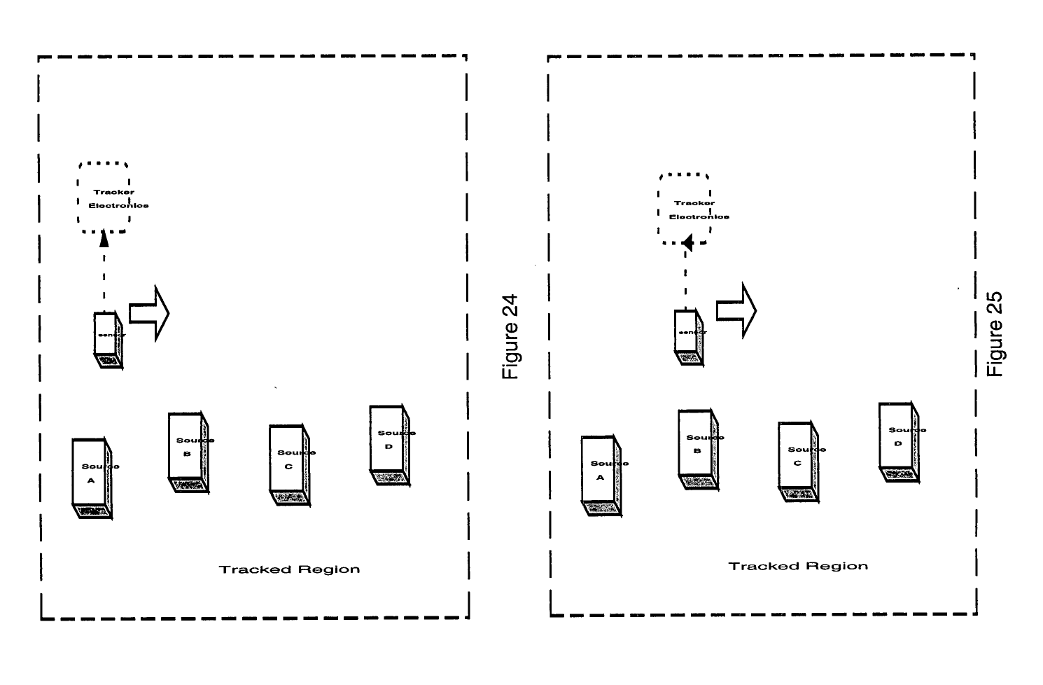

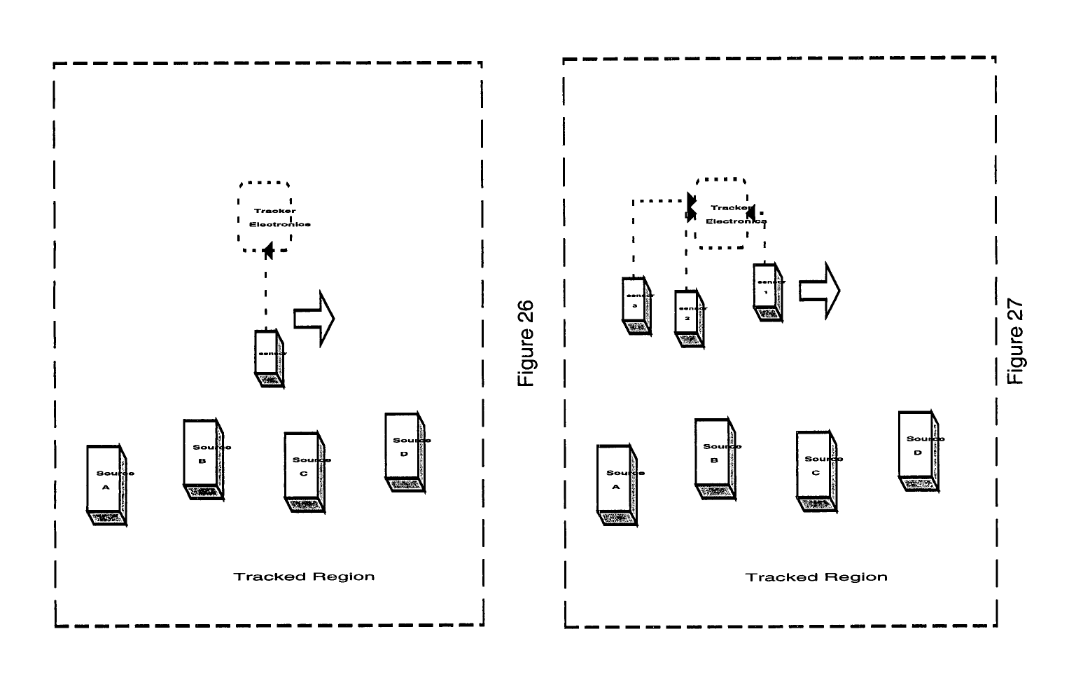

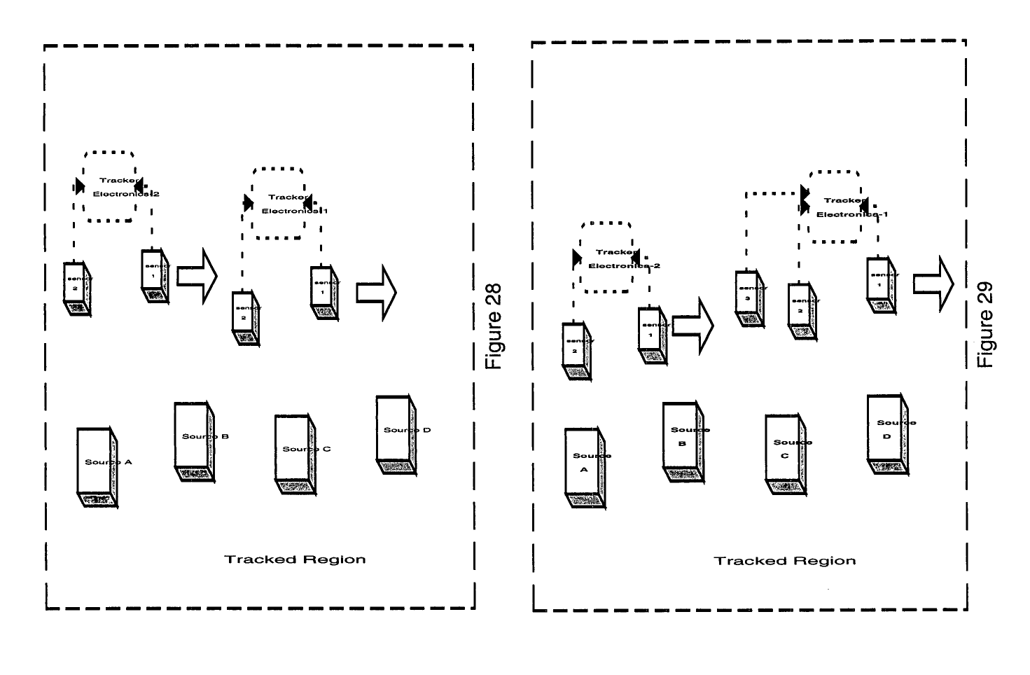

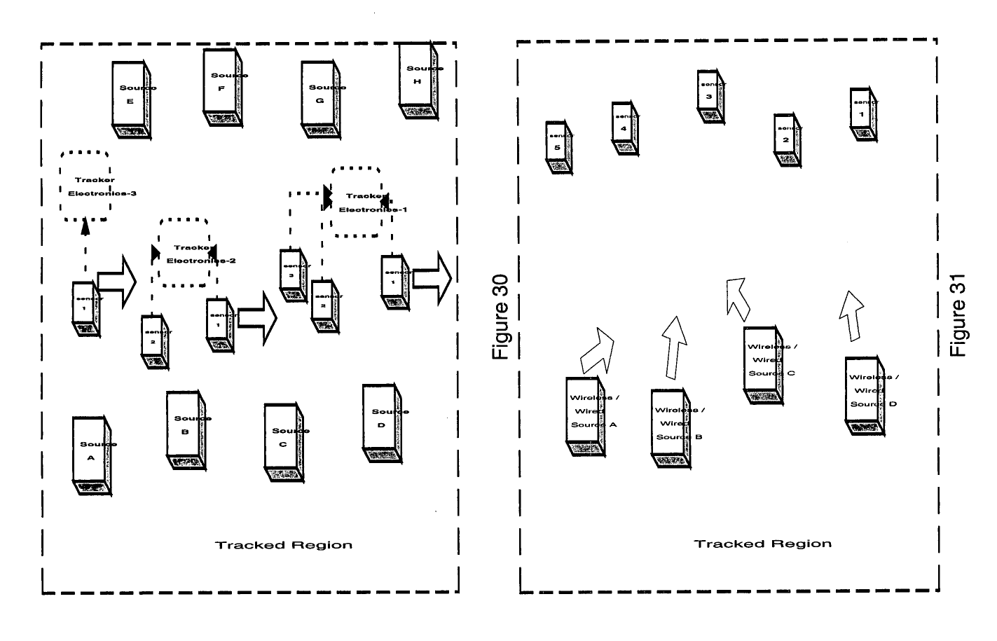

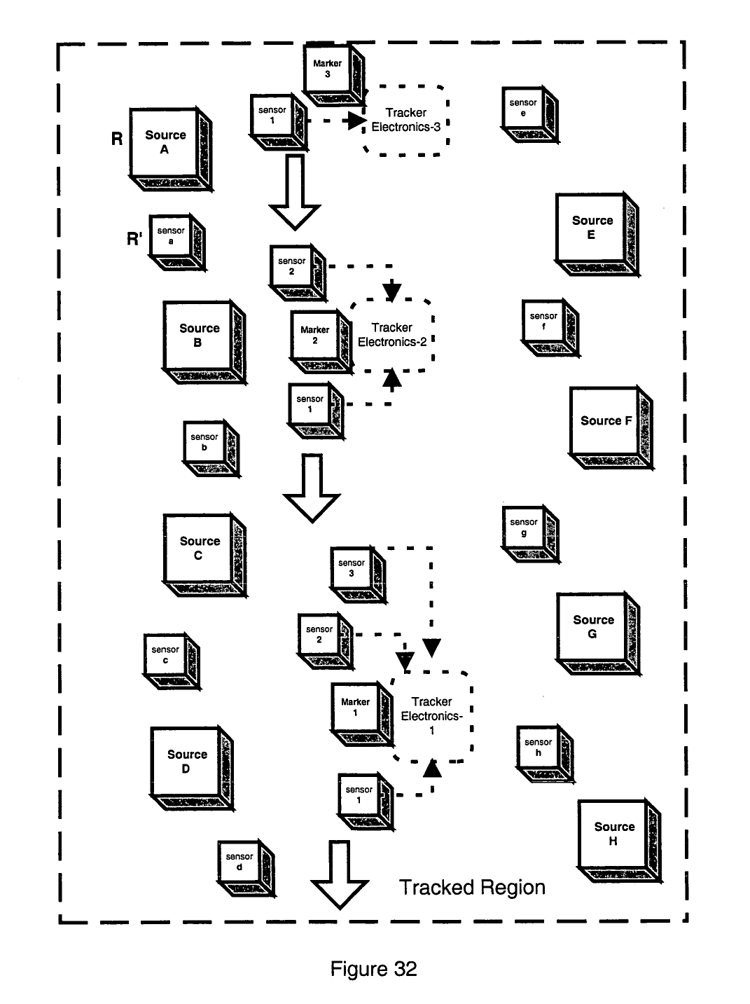

FIGS. 24 to 30 show how a single field source out of the several placed in the environment can become the coordinate reference point and that several trackers of various configurations can move through the environment and that the environment even can be expanded by bringing in more distributed sources (FIG. 30). The first sensor in the environment goes past the reference source and then uses the sensor location from it to locate the next source as its signal levels are acquired and then the next and the next. Once the source locations are established, the remaining sensor can enter the environment arbitrarily and have their P&O reported through the reference source location even when range is too far to reach between them. FIG. 31 repeats the concept of the fixed sensor and mobile marker architecture which functions in a similar way to report source P&O related to a reference sensor. Both of these concepts are combined in FIG. 32.

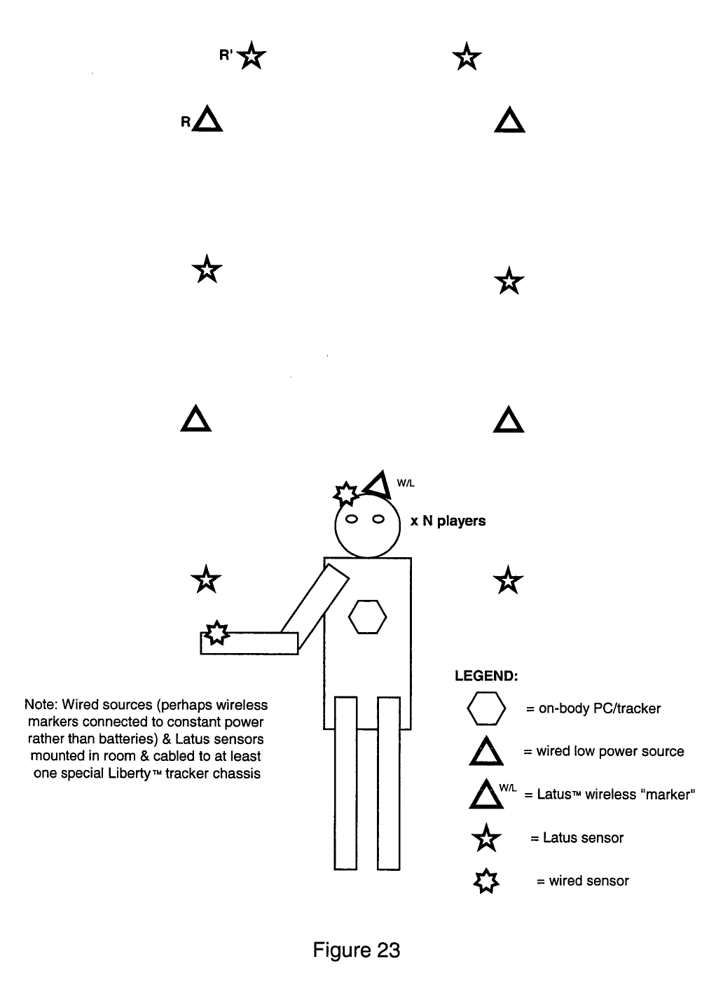

FIG. 20 then allows a system configuration like that depicted in FIG. 23. The Liberty™ 3D tracking system¹ is ideal for this application although other systems of like capability could be used. For instance, the trackers carried on the actor's body may be an off-shoot of the Liberty technology operating under battery power. Several choices are available for operating actor tracking over the volume.
¹ Product introduced in 2004 by Polhemus, Colchester, Vt.

As an outside-in tracker the sources are driven and the tracker(s) on the actor(s) obtain P&O which can be used in two ways: 1) Actor sensor data (from 8-pointed stars in FIG. 23) referenced to the chosen reference source installed in the workspace, or 2) body movement within the environment based on the sensor on the head and limb sensor tracking through tracking sensors relative to the wireless (or wired to electronics on the body) marker on the head. In both cases the P&O data would be retained on the actor's body unless some RF link is arranged. Cabling from the tracker to the sensors on the body would be necessary. In other words, in the absence of an RF data link data would be captured in real-time but would require playback offline, a situation that many mocap organizations seem to use. In the instance where no real-time link is available then each sensor entering the environment must re-establish the distributed source locations if data are to be reported via the reference source.

As an inside-out tracker, the LATUS™ sensors (5-pointed stars in FIG. 23) can provide tracking for the marker and/or the tracker source on the actor's head (or wherever it may be mounted), and for additional markers that may be placed on the body. If an all-LATUS marker configuration tracks the actor's body, the data would be instantly available to the outside world without RF link being required. This would allow both real-time collection and real-time display.

As a combined outside-in and inside-out, or out-in-out, system the following becomes possible. 1) The LATUS sensors can verify location, or help determine placement, of the distributed sources since their location related to the sources will be known by the system; 2) Real-time tracking of the actor(s) can be accomplished while actor limb motions are recorded² on the body either by using the distributed source signals or the wireless marker on his body and do so with many sensors because the tracker on the body does not have its assets committed doing anything else; 3) If it is desired to relate all P&O measurements to the reference LATUS sensor, this can be done and can be done in real-time if tracker data captured on the body is linked to the host system; 4) All marker P&O data collected by the trackers similarly can be related to the reference source if so designated to the LATUS tracking system which already will know its coordinates.
² Apparatus for providing time stamps on data between the fixed and mobile tracker data must be made available so the proper timing relationship is available at playback. Enough buffer memory also must be provided on any mobile tracker to avoid overflow during the anticipated data collection time interval.

In summary, we have disclosed novel performance options for P&O tracking over a large region using both an array of low power field sources in order to maximize tracking range and minimize or avoid the effects of field distortion and an array of sensors to track signal source markers. At the outset the tracking system(s) is(are) triggered to learn the location of a reference field source and/or a reference sensor for markers. All subsequent P&O data reports can then be translated and rotated to these references after the system itself learns their locations. The fixed array of sensors also can locate the distributed sources, and all tracker outputs could be related to either reference device coordinate set. Mobile trackers carried on an actor can either record tracking data to memory for later playback or be fitted with a radio link for real-time application. Different sets of frequencies make each source and marker uniquely identifiable while traveling throughout the volume. This means of launching a system environment where the tracking systems determine the reference coordinates is a great convenience over trying to do so using the tools of mechanical metrology. Creation of a tracking environment combining both approaches thus offers unique capabilities.

1. In an AC magnetic tracking system, a self-calibration method comprising the steps of:
a) positioning a plurality of stationary AC magnetic markers in a tracking volume;
b) moving a mobile AC magnetic marker counterpart proximate to a first one of the stationary markers designated as a reference marker;
c) determining the position and orientation (P&O) of the mobile marker relative to the reference marker;
d) moving the mobile marker to a second one of the stationary markers;
e) determining the P&O of the second marker relative to the reference marker;
f) determining the P&O of the mobile marker relative to the reference marker based upon the P&O of the second marker relative to the reference marker.

2. The method of claim 1, including the step of repeating steps b) through f) using one or more additional stationary markers present in the tracking volume.

3. The method of claim 1, including the step of storing the coordinates of the stationary markers for future use.

4. The method of claim 1, including the step of providing the stationary markers on a fixture, such that after the completion of steps b) through f), only the P&O of the mobile marker relative to the reference marker need be determined for a subsequent use of the system.

5. The method of claim 1, including wired or wireless markers.

6. The method of claim 1, wherein:
the stationary markers are AC magnetic sensors; and
the mobile marker is an AC magnetic source.

7. The method of claim 1, wherein:
the stationary markers are AC magnetic sources; and
the mobile marker includes an AC magnetic sensor.

8. The method of claim 1, wherein:
the stationary markers are AC magnetic sources, each operating on a different frequency set; and
the mobile marker includes an AC magnetic sensor.

9. The method of claim 1, wherein:
the stationary markers are AC magnetic sources; and
the mobile marker includes a plurality of cooperative AC magnetic sensors.

10. The method of claim 1, wherein:
the stationary markers are AC magnetic sources;
the mobile marker includes an AC magnetic sensors; and
the signal strength associated with the sources is taken into account when determining the P&O of the mobile marker.

11. The method of claim 1, further including the steps of:
determining the position and orientation (P&O) of the mobile marker relative to some or all of the stationary markers.

12. The method of claim 1, wherein:
some of the markers are distributed sources operating at different, distinguishable frequency sets; and
other markers includes sensors monitoring mobile “marker” sources, also operating at different frequency sets.

13. The method of claim 1, wherein the reference marker is generally surrounded by stationary markers.

14. An AC magnetic tracking system, comprising:
a plurality of stationary AC magnetic markers supported in a tracking volume;
a mobile AC magnetic marker adapted for movement proximate to some or all of the stationary AC magnetic markers, with one of the stationary markers being designated as a reference marker; and
a processing operative to determine:
the position and orientation (P&O) of the mobile marker,
the P&O of the second marker relative to the reference marker, and
the P&O of the mobile marker relative to the reference marker based upon the P&O of the second marker relative to the reference marker.

15. The system of claim 14, including one or more additional stationary markers in the tracking volume.

16. The system of claim 14, including a memory for storing the coordinates of the stationary markers for future use.

17. The system of claim 14, including a fixture supporting the stationary markers, such that only the P&O of the mobile marker relative to the reference marker need be determined for a subsequent use of the system.

18. The system of claim 14, wherein the markers are wired or wireless.

19. The system of claim 14, wherein:
the stationary markers are AC magnetic sensors; and
the mobile marker is an AC magnetic source.

20. The system of claim 14, wherein:
the stationary markers are AC magnetic sources; and
the mobile marker includes an AC magnetic sensor.

21. The system of claim 14, wherein:
the stationary markers are AC magnetic sources, each operating on a different frequency set; and
the mobile marker includes an AC magnetic sensor.

22. The system of claim 14, wherein:
the stationary markers are AC magnetic sources; and
the mobile marker includes a plurality of cooperative AC magnetic sensors.

23. The system of claim 14, wherein:
the stationary markers are AC magnetic sources;
the mobile marker includes an AC magnetic sensors; and
the signal strength associated with the sources is taken into account when determining the P&O of the mobile marker.

24. The system of claim 14, including distributed sources operating at different, distinguishable frequency sets and sensors monitoring mobile “marker” sources also operating at different frequency sets provide unique motion tracking architectures.

25. The system of claim 14, wherein the reference marker is generally surrounded by stationary markers.
